(19) United States
(12) Patent Application Publication
(10) Pub. No.: US 2022/0122015 A1
(43) Pub. Date: Apr. 21, 2022

(54) ARTIFICIAL INTELLIGENCE AUTOMATION MANAGEMENT SYSTEM AND METHOD

(71) Applicants: Aparajita BANDOPADHYAY, Bangalore (IN); Oishani BANDOPADHYAY, Bangalore (IN); Tapati BANDOPADHYAY, Bangalore (IN)

(72) Inventors: Aparajita BANDOPADHYAY, Bangalore (IN); Oishani BANDOPADHYAY, Bangalore (IN); Tapati BANDOPADHYAY, Bangalore (IN)

(21) Appl. No.: 17/393,783

(22) Filed: Aug. 4, 2021

(30) Foreign Application Priority Data
Oct. 20, 2020 (IN) 202041045654

(51) Int. Cl. G06Q 10/06; G06N 20/00; G06Q 30/00; G06Q 10/10

(52) U.S. Cl. CPC G06Q 10/06375; G06N 20/00; G06Q 30/018; G06Q 10/105; G06Q 10/0635; G06Q 10/103; G06Q 10/06313

(57) ABSTRACT

An artificial intelligence (AI) automation management system is provided. The system includes one or more processors and a computer readable storage device. The one or more processors are configured to receive input parameters for a plurality of AI automation assets and/or applications configured to facilitate operation of an enterprise and to receive control factors for each of the plurality of AI automation assets and/or applications. The processors are configured to receive technology parameters for each of the plurality of AI automation assets. The one or more processors are configured to generate output parameters corresponding to each of the plurality of AI automation assets. The one or more processors are further configured to analyze each of the input parameters, control factors, technology parameters and output parameters to manage and/or facilitate operation of each of the plurality of AI automation assets and/or applications to deliver targeted outcomes for the enterprise.

### PRIORITY STATEMENT

The present application claims priority under 35 U.S.C. § 119 to Indian patent application number 202041045654 filed Oct. 20, 2020, the entire contents of which are hereby incorporated herein by reference.

### FIELD

The invention relates generally to artificial intelligence (AI) systems and, more particularly to, an AI automation management system for enterprises.

### BACKGROUND

AI and intelligent automation is being widely used in organizations and in the current scenario is expected to see massive production-scale adoption across enterprise applications, especially in IT and business domains. Currently, AI technology and service providers are developing their own versions of maturity models for managing the AI automation process for an enterprise. Unfortunately, there are no empirical sets of tools and techniques available that can help end-user enterprise leaders and their technology and service provider partners to benchmark and plan their AI strategy, technology adoption and journey.

Moreover, there is no empirical, data-driven, evidence-based process framework for AI and automation solutions lifecycle management that can be used for enterprises. In some situations, where number of automation assets/bots and AI solutions is small, existing tools such as spreadsheets are used to manage data and parameters for release controls, from governance, risk, compliance perspectives and so forth. However, in situations where such implementations become large and complex, the integrations and dependencies go beyond simple tasks to end-to-end processes, governance, effectiveness and incidents, availability and escalation management of these bots. In these situations, AI solutions becomes highly complex and cumbersome, and cannot be supported only through individual platform orchestrators or reporting modules or with individually managed spreadsheets.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment an artificial intelligence (AI) automation management system is provided. The system includes one or more processors and a computer readable storage device operatively coupled to the one or more processors. The one or more processors are configured to execute the computer-readable instructions stored on the computer readable storage device to receive input parameters for a plurality of AI automation assets and/or applications configured to facilitate operation of an enterprise and to receive control factors for each of the plurality of AI automation assets and/or applications. The input parameters correspond to one or more of strategy, workforce, information, technology and culture related parameters. Further, the control factors include factors related to trust and regulations, bias mitigation strategies, social-technological-economic-political (STEP) factors, green and sustainability parameters, ethical AI practices, and combinations thereof. The one or more processors are further configured to receive technology parameters for each of the plurality of AI automation assets. The technology parameters include parameters related to input data quality, bias, change relevance, algorithms deployed by the AI automation assets, assets catalogues, green and sustainability parameters of infrastructure, and combinations thereof. The one or more processors are further configured to generate output parameters corresponding to each of the plurality of AI automation assets. The output parameters include human-AI augmentation metrics, cost details, adoption metrics, impact on market share, impact on profitability metrics, and combinations thereof. The one or more processors are further configured to analyze each of the input parameters, control factors, technology parameters and output parameters to manage and/or facilitate operation of each of the plurality of AI automation assets and/or applications to deliver targeted outcomes for the enterprise.

According to another example embodiment, an artificial intelligence (AI) automation management system is provided. The system includes one or more AI automation input modules configured to receive a plurality of input parameters corresponding to plurality of AI automation assets and/or applications of an enterprise. The input parameters correspond to one or more of strategy, workforce, information, technology and culture related parameters. The system also includes one or more AI automation output modules communicatively coupled to at least one AI automation input modules. The one or more AI automation output modules is configured to generate output parameters corresponding to each of the plurality of AI automation assets. The output parameters include human-AI augmentation metrics, cost details, adoption metrics, impact on market share, profitability metrics, and combinations thereof. The system also includes one or more AI processing modules configured to analyze the plurality of input parameters received from the one or more AI automation input modules and the output parameters received from the one or more AI automation output modules to manage and/or facilitate operation of each of the plurality of AI automation assets and/or applications to deliver targeted outcomes for the enterprise.

According to another example embodiment, a computer-implemented method for managing AI automation of an enterprise is provided. The method includes receiving input parameters for a plurality of AI automation assets and/or applications deployed for the enterprise. The input parameters correspond to one or more of strategy, workforce, information, technology and culture related parameters. The method also includes receiving control factors for each of the plurality of AI automation assets and/or applications. The control factors include factors related to trust and regulations, bias mitigation strategies, social-technological-economic-political (STEP) factors, green and sustainability parameters, ethical AI practices, and combinations thereof. The method includes receiving technology parameters for each of the plurality of AI automation assets. The technology parameters include parameters related to input data quality, bias, change relevance, algorithms deployed by the AI automation assets, assets catalogues, green and sustainability parameters and combinations thereof. The method further includes generating output parameters corresponding to each of the plurality of AI automation assets. The output parameters include human-AI augmentation metrics, cost details, adoption metrics, impact on market share, profitability metrics, and combinations thereof. The method also includes processing each of the input parameters, control factors, technology parameters and output parameters to manage and/or facilitate operation of each of the plurality of AI automation assets and/or applications to deliver targeted outcomes for the enterprise.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 illustrates an artificial intelligence (AI) automation management system for an enterprise in accordance with embodiments of the present technique;

FIG. 2 illustrates an example embodiment illustrating the operation of the AI processing modules of system of FIG. 1 in accordance with embodiments of the present technique;

FIG. 3 is a flow diagram for a process for managing AI automation of an enterprise, using the system of FIG. 1, according to the aspects of the present technique; and

FIG. 4 is a block diagram of an embodiment of a computing device in which the modules of the AI automation management system, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in ‘addition to the orientation depicted in the figures. For example, if the device in the figures is turned over, elements described as “below” or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The device(s)/apparatus(es), described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described example embodiments of the inventive concept may be implemented with program instructions which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments are generally directed to artificial intelligence (AI) systems and more particularly to, an AI automation management system for enterprises. In particular, the techniques described here provides an integrated framework to facilitate implementation of AI strategy and technology adoption for a wide variety of enterprises using AI tools.

The AI automation management system described herein provides an integrated framework that focuses on AI and automation solution lifecycles post development and in production or in operations. The system provides data debiasing and ethical and explainable AI considerations along with forward-looking techniques for measuring green and sustainable AI technologies and practices and their effectiveness.

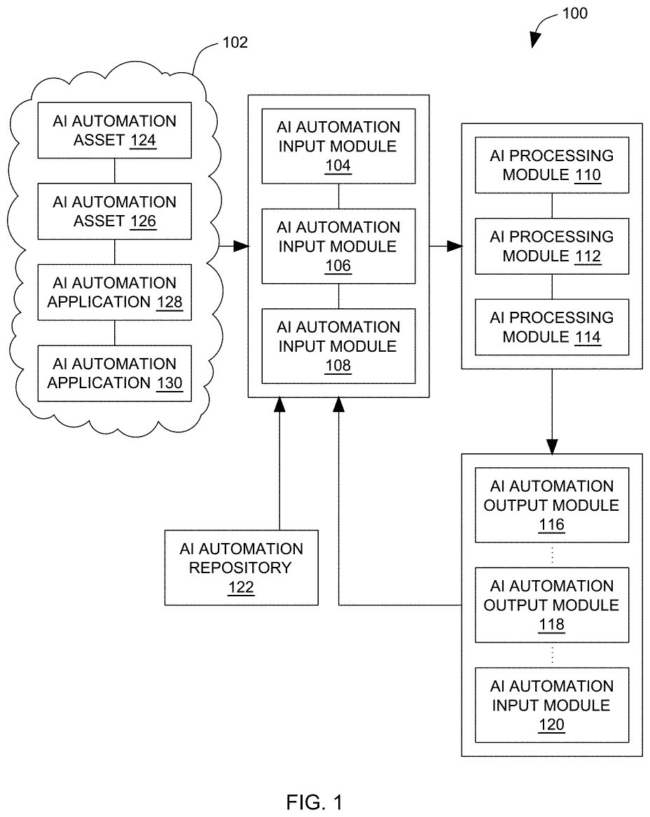

FIG. 1 illustrates an artificial intelligence (AI) automation management system 100 for an enterprise 102 in accordance with embodiments of the present technique. The system 100 includes one or more AI automation input modules such as represented by reference numerals 104, 106 and 108, one or more AI processing modules such as represented by reference numerals 110, 112 and 114, one or more AI automation output modules such as represented by reference numerals 116, 118 and 120 and an AI automation repository 122. Each component of the system 100 is described in further detail below.

In the illustrated embodiment, the one or more AI automation input modules 104, 106 and 108 are configured to receive a plurality of input parameters corresponding to a plurality of AI automation assets and/or applications generally represented by reference numerals 124, 126, 128 and 130 of the enterprise 102. As will be appreciated by one skilled in the art the enterprise 102 may include a number of AI automation assets such as AI bots and/or applications to facilitate operation of the enterprise. Such AI automation assets and/or applications 124, 126, 128 and 130 may be deployed across enterprise applications, in IT and business domains and other functions of the enterprise 102 to automating end-to-end business and IT processes. For example, the AI automation assets and/or applications 124, 126, 128 and 130 may be used for automating an accounts payable process including sub-processes such as verifying duplicate invoices or identification of quantity/price anomalies and so forth. A variety of other processes may be envisaged where the AI automation assets and/or applications 124, 126, 128 and 130 may be deployed to automate and manage the processes.

In the illustrated embodiment, the input parameters received from the AI automation assets and/or applications 124, 126, 128 and 130 may correspond to one or more of strategy, workforce, information, technology and culture related parameters of the enterprise 102. As can be seen, the system 100 includes the one or more AI automation output modules 116, 118 and 120 communicatively coupled to at least one of the AI automation input modules 104, 106 and 108. The one or more AI automation output modules 116, 118 and 120 are configured to generate output parameters corresponding to each of the plurality of AI automation assets 124, 126, 128 and 130. Examples of the output parameters comprise human-AI augmentation metrics, cost details, adoption metrics, impact on market share, profitability metrics, and combinations thereof. It should be noted that the output parameters may include other relevant data based on a type of the enterprise, type of the process to be automated, number and type of automation assets and/or applications and so forth.

In addition, the one or more AI processing modules 110, 112 and 114 are configured to analyze the plurality of input parameters received from the one or more AI automation input modules 104, 106 and 108 and the output parameters received from the one or more AI automation output modules 116, 118 and 120 to manage and/or facilitate operation of each of the plurality of AI automation assets and/or applications assets 124, 126, 128 and 130 to deliver targeted outcomes for the enterprise 102. In certain embodiments, the one or more AI processing modules 110, 112 and 114 are configured to monitor and track a plurality of interactions between the one or more AI automation input modules 104, 106 and 108 and the one or more AI automation output modules 116, 118 and 120. For example, the interactions may include an output from one or more modules being delivered as an input to another module.

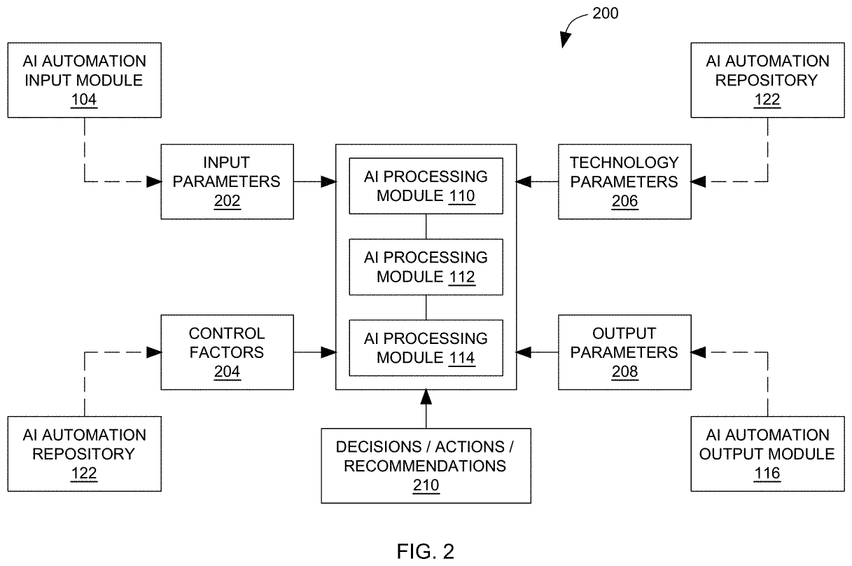

In the illustrated embodiments, the one or more AI processing modules 110, 112 and 114 are operatively coupled to the one or more AI automation input modules 104, 106 and 108 and the one or more AI automation output modules 116, 118 and 120. In certain embodiments, the AI processing modules may be integrated with the AI automation output modules. In the illustrated embodiment, the AI automation repository 122 is configured to store the input parameters, output parameters and the recommendations/actions generated by the system 100. The processing of the input and output parameters will be described below with reference to FIG. 2.

FIG. 2 illustrates an example embodiment 200 of the system 100 illustrating the operation of the AI processing modules such as 110, 112 and 114 in accordance with embodiments of the present technique.

In the illustrated embodiment, the AI processing modules such as 110, 112 and 114 are configured to receive input parameters 202 for the AI automation assets and/or applications 124, 126, 128 and 130. Here, wherein the input parameters 202 correspond to one or more of strategy, workforce, information, technology and culture related parameters for the enterprise 102. The input parameters 202 may be received from the AI automation input modules 104, 106 and 108 that are operatively coupled to the AI automation assets and/or applications 124, 126, 128 and 130. In certain embodiments, the input parameters 202 may be accessed from the AI automation repository 122. The input parameters 202 may be user-defined for each of the AI automation assets and/or applications 124, 126, 128 and 130. In other embodiments, the input parameters 202 may include real-time parameters monitored for the assets and/or applications 124, 126, 128 and 130.

The AI processing modules such as 110, 112 and 114 are configured to receive control factors 204 for each of the plurality of AI automation assets and/or applications 124, 126, 128 and 130. The control factors 204 include factors related to trust and regulations, bias mitigation strategies, social-technological-economic-political (STEP) factors, green and sustainability parameters, ethical AI practices, and combinations thereof. Such control factors 204 may be accessed from the AI automation repository 122. The control factors 204 may be updated on a periodic basis by a user of the enterprise 102.

The AI processing modules such as 110, 112 and 114 are further configured to receive technology parameters 206 for each of the plurality of AI automation assets 124, 126, 128 and 130. The technology parameters comprise parameters related to input data quality, bias, change relevance, algorithms deployed by the AI automation assets 124, 126, 128 and 130, assets catalogues, green and sustainability parameters of infrastructure, and combinations thereof. Again, a number of other technology parameters 206 may be provided to the AI processing modules such as 110, 112 and 114 based upon a type of the enterprise 102 and the type of the AI automation assets 124, 126, 128 and 130. Such technology parameters 206 may be accessed from the AI automation repository 122.

The AI processing modules such as 110, 112 and 114 are further configured to receive output parameters 208 corresponding to each of the plurality of AI automation assets 124, 126, 128 and 130. The output parameters 208 may include, but not limited to, human-AI augmentation metrics, cost details, adoption metrics, impact on market share, impact on profitability metrics, and combinations thereof. Such technology parameters 206 may be received from the AI automation output module such as 116 or may be accessed from the AI automation repository 122.

The AI processing modules such as 110, 112 and 114 are configured to analyze each of the input parameters 202, control factors 204, technology parameters 206 and output parameters 208 to manage and/or facilitate operation of each of the plurality of AI automation assets and/or applications 124, 126, 128 and 130 to deliver targeted outcomes for the enterprise 102. For example, the AI processing modules 110, 112 and 114 are configured to determine AI and automation strategy for the enterprise 102 using one or more of the input parameters 202, control factors 204, technology parameters 206 and the output parameters 208 for the plurality of AI automation assets and/or applications 124, 126, 128 and 130. Such strategy/actions may be available to a user of the enterprise via an interface 210.

In one example, the system 100 is configured to identify and manage the AI and automation strategy for the enterprise 102 and to estimate and manage ROI of the plurality of AI automation assets and/or applications 124, 126, 128 and 130. Moreover, the system 100 is configured to estimate and/or manage risk metrics for each of the plurality of AI automation assets and/or applications 124, 126, 128 and 130 and define and/or manage strategic outcomes for each of the plurality of AI automation assets and/or applications 124, 126, 128 and 130. Further, the system 100 is configured to determine and/or manage business and operational outcomes for each of the plurality of AI automation assets and/or applications 124, 126, 128 and 130 to perform AI automation journey-mapping for the enterprise 102 and to generate relevant metrics such as automation strategy, risk metrics, financial impact metrics, strategic maps corresponding to strategic outcomes, and combinations thereof for the enterprise 102.

In another example, the system 100 is configured to generate and/or evaluate AI automation strategies for one or more automation sub units of the enterprise 102. Here, each sub unit includes a plurality of AI automation assets and/or applications such as 124, 126, 128 and 130 configured to facilitate operation of the respective automation sub unit. The system 100 is configured to analyze and manage people skills and resources for each of the one or more automation sub units and to manage training needs of human resources for each of the one or more automation sub units based on the analysis data. The system 100 is further configured to develop and manage organization structures for the enterprise 102 and to determine and manage AI automation workforce costs for each of the automation sub units. The system 100 is configured to generate metrics such as skill maps, skill metrics, skill trends, training outcomes, training effectiveness, training costs, workforce data, automation costs, automation cost trends, and combinations thereof for the enterprise 102.

In another example, the system 100 is configured to manage information security for each of the plurality of AI automation assets and/or applications such as 124, 126, 128 and 130 and to formulate and implement data relevance strategies for each of the plurality of AI automation assets and/or applications 124, 126, 128 and 130. The system 100 is configured to manage data de-biasing and quality checks for datasets used by the plurality of AI automation assets and/or applications such as 124, 126, 128 and 130 and evaluate data utilization efficiency and implement data change strategies based on the evaluated data utilization efficiency. The system 100 is further configured to implement AI automation information management strategies for selective AI automation assets and/or applications 124, 126, 128 and 130 having data availability lesser than a pre-defined threshold and to generate security threat trends, data relevance metrics, data bias and data quality metrics, data change triggers, data usage trends, and combinations thereof.

In another example, the system 100 is configured to evaluate and manage technology infrastructure requirements for the plurality of AI automation assets and/or applications 124, 126, 128 and 130 and to manage green-ness and carbon foot print for the plurality of AI automation infrastructure assets and/or applications 124, 126, 128 and 130 in accordance with the overall strategy for the enterprise. The system 100 is configured to define and implement a global technology change and operations management strategy for the plurality of AI automation assets and/or applications 124, 126, 128 and 130 to manage changes resulting from service incidences, traces and events, client requirements, operational changes, or combinations thereof. The system 100 is configured to evaluate technology performance and innovation management for each of the plurality of AI automation assets and/or applications 124, 126, 128 and 130 with respect to pre-determined benchmarks and to formulate and implement enterprise-level AI & automation infrastructure cost management and capacity utilization strategy across each of the plurality of AI automation assets and/or applications 124, 126, 128 and 130. The system 100 is also configured to determine technology management data, wherein the data comprises at least one of assets capacity trends, green scores, asset criticality metrics, cost metrics for each of the plurality of AI automation assets and/or applications 124, 126, 128 and 130, or combinations thereof.

In another example, the system 100 is configured to manage organizational change plans for the plurality of AI automation assets and/or applications 124, 126, 128 and 130 and to evaluate and manage adoption models for the plurality of AI automation assets and/or applications 124, 126, 128 and 130. The system 100 is configured to establish and implement communication and trust management plans for the plurality of AI automation assets and/or applications 124, 126, 128 and 130 and manage AI and automation thought diversity management process for the plurality of AI automation assets and/or applications 124, 126, 128 and 130. based on a plurality of diversity parameters. The system is further configured to formulate and implement enterprise level Environmental Sustainability & Green (ESG) strategies for each of the plurality of AI automation assets and/or applications 124, 126, 128 and 130 and to determine and track AI automation triggered organizational changes metrics, adoption rates, trust scores, carbon foot print data, or combinations thereof for the plurality of AI automation assets and/or applications 124, 126, 128 and 130.

In another example, the system 100 is configured to manage and track human-AI collaboration strategy and outcomes for each of the plurality of AI automation assets and/or applications 124, 126, 128 and 130 and to assess human behavioural impact of the human-AI collaboration for each of the plurality of AI automation assets and/or applications 124, 126, 128 and 130. The system 100 is configured to assess technology effectiveness of the human-AI collaboration for each of the plurality of AI automation assets and/or applications 124, 126, 128 and 130, to identify and/or assess STEP impact of the human-AI collaboration for each of the plurality of AI automation assets and/or applications 124, 126, 128 and 130. The system 100 is also configured to assess innovation effectiveness of the human-AI collaboration for each of the plurality of AI automation assets and/or applications 124, 126, 128 and 130 and to measure and track at human-AI collaboration parameters, wherein the human-AI collaboration parameters comprise at least one of business impact metrics, behavioural impact data, user satisfaction scores, STEP impact data and adoption data.

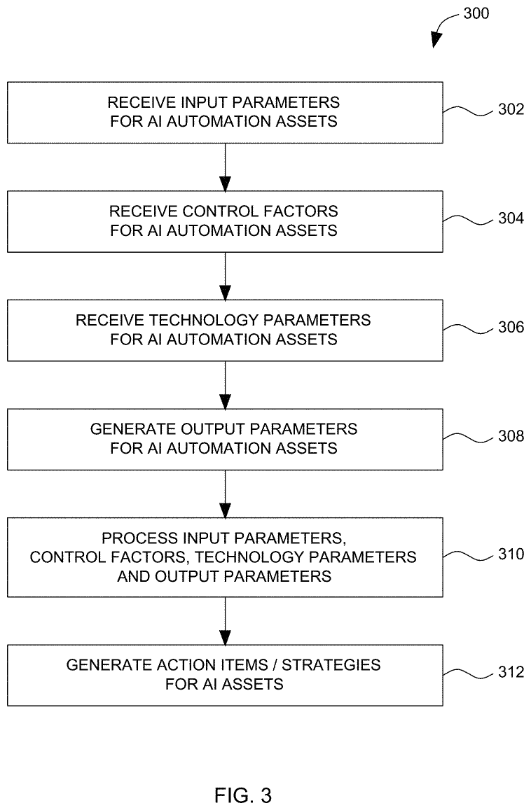

FIG. 3 is a flow diagram for illustrating a computer-implemented process 300 for managing AI automation of an enterprise, using the system 100 of FIG. 1, according to the aspects of the present technique. At block 302, input parameters for a plurality of AI automation assets and/or applications deployed for the enterprise are received. The input parameters correspond to one or more of strategy, workforce, information, technology and culture related parameters.

At block 304, control factors for each of the plurality of AI automation assets and/or applications are received. The control factors include factors related to trust and regulations, bias mitigation strategies, social-technological-economic-political (STEP) factors, green and sustainability parameters, ethical AI practices, and combinations thereof.

At block 306, technology parameters for each of the plurality of AI automation assets are received. The technology parameters include parameters related to input data quality, bias, change relevance, algorithms deployed by the AI automation assets, assets catalogues, green and sustainability parameters and combinations thereof.

At block 308, output parameters corresponding to each of the plurality of AI automation assets are generated. The output parameters include human-AI augmentation metrics, cost details, adoption metrics, impact on market share, profitability metrics, and combinations thereof. At block 310, each of the input parameters, control factors, technology parameters and output parameters are processed and action items, output metrics and strategies are generated (block 312) to manage and/or facilitate operation of each of the plurality of AI automation assets and/or applications to deliver targeted outcomes for the enterprise.

In certain embodiments, the process 300 further comprises customizing the AI automation process based on type of enterprise, types of the plurality of AI automation assets and/or applications, governance guidelines, risk and lifecycle management, environment compliance, compliance standards, and combinations thereof. Moreover, the enterprise AI adoption and transformation strategies of the enterprise are managed based on the generated strategies. In this example, the process further includes implementing and managing strategy and financial process, workforce, information, technology, culture and human-AI collaboration for the enterprise. Also, the process includes monitoring interactions between the one or more processes related to the strategy and financial process, workforce, information, technology, culture and human-AI collaboration for the enterprise.

The AI automation management system described above provides a framework that is not bulky/voluminous, and can be adopted rapidly by an organization of any size, to help them manage their AI-automation solutions/assets deployed in production. It should be noted that the process framework is lean, having only the required processes required to manage enterprise AI-automation assets effectively and efficiently. The system also provides a flexible framework wherein each process is clearly defined with its objectives, sub-processes, example steps, metrics and RACI.

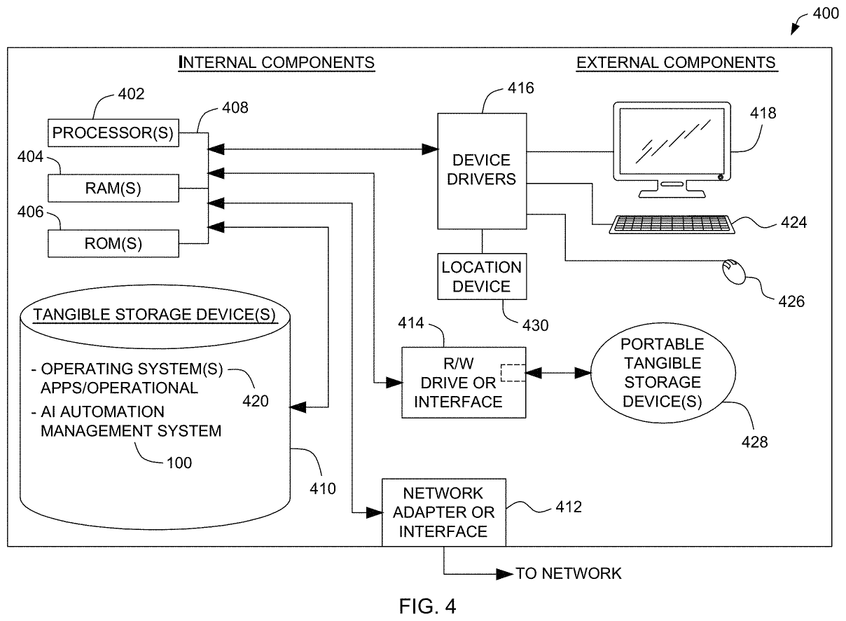

The modules of the AI automation management system 100 described herein are implemented in computing devices. One example of a computing device 400 is described below in FIG.4. The computing device includes one or more processor 402, one or more computer-readable RAMs 404 and one or more computer-readable ROMs 406 on one or more buses 508. Further, computing device 400 includes a tangible storage device 410 that may be used to execute operating systems 420 and the AI automation management system 100. Both, the operating system 420 and the storage system 100 are executed by processor 402 via one or more respective RAMs 404 (which typically includes cache memory). The execution of the operating system 420 and/or the system 100 by the processor 402, configures the processor 402 as a special purpose processor configured to carry out the functionalities of the operation system 420 and/or the AI automation management system 100, as described above.

Examples of storage devices 410 include semiconductor storage devices such as ROM 506, EPROM, flash memory or any other computer-readable tangible storage device that may store a computer program and digital information.

Computing device also includes a R/W drive or interface 414 to read from and write to one or more portable computer-readable tangible storage devices 428 such as a CD-ROM, DVD, memory stick or semiconductor storage device. Further, network adapters or interfaces 412 such as a TCP/IP adapter cards, wireless Wi-Fi interface cards, or 3G or 4G wireless interface cards or other wired or wireless communication links are also included in computing device.

In one example embodiment, the system 100 may be stored in tangible storage device 410 and may be downloaded from an external computer via a network (for example, the Internet, a local area network or other, wide area network) and network adapter or interface 412.

Computing device further includes device drivers 416 to interface with input and output devices. The input and output devices may include a computer display monitor 418, a keyboard 424, a keypad, a touch screen, a computer mouse 426, and/or some other suitable input device.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewritable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewritable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewritable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewritable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

1. An artificial intelligence (AI) automation management system, comprising:
one or more processors;
a computer readable storage device operatively coupled to the one or more processors and having computer-readable instructions stored thereon, which when executed by the one or more processors, cause the one or more processors to:
receive input parameters for a plurality of AI automation assets and/or applications configured to facilitate operation of an enterprise, wherein the input parameters correspond to one or more of strategy, workforce, information, technology and culture related parameters;
receive control factors for each of the plurality of AI automation assets and/or applications, wherein the control factors comprise factors related to trust and regulations, bias mitigation strategies, social-technological-economic-political (STEP) factors, green and sustainability parameters, ethical AI practices, and combinations thereof;
receive technology parameters for each of the plurality of AI automation assets, wherein the technology parameters comprise parameters related to input data quality, bias, change relevance, algorithms deployed by the AI automation assets, assets catalogues, green and sustainability parameters of infrastructure, and combinations thereof;
generate output parameters corresponding to each of the plurality of AI automation assets, wherein the output parameters comprise human-AI augmentation metrics, cost details, adoption metrics, impact on market share, impact on profitability metrics, and combinations thereof;
analyze each of the input parameters, control factors, technology parameters and output parameters to manage and/or facilitate operation of each of the plurality of AI automation assets and/or applications to deliver targeted outcomes for the enterprise.

2. The AI automation management system of claim 1, wherein the one or more processors are configured to execute the computer-readable instructions to determine AI and automation strategy for the enterprise using one or more of the input parameters, control factors, technology parameters and the output parameters for the plurality of AI automation assets and/or applications.

3. The AI automation management system of claim 2, wherein the one or more processors are configured to execute the computer-readable instructions to:
identify and manage the AI and automation strategy for the enterprise;
estimate and manage ROI of the plurality of AI automation assets and/or applications;
estimate and/or manage risk metrics for each of the plurality of AI automation assets and/or applications;
define and/or manage strategic outcomes for each of the plurality of AI automation assets and/or applications;
determine and/or manage business and operational outcomes for each of the plurality of AI automation assets and/or applications;
perform AI automation journey-mapping for the enterprise; and
generate automation strategy, risk metrics, financial impact metrics, strategic maps corresponding to strategic outcomes, and combinations thereof for the enterprise .

4. The AI automation management system of claim 1, wherein the one or more processors are configured to execute the computer-readable instructions to:
generate and/or evaluate AI automation strategies for one or more automation sub units of the enterprise, each sub unit having a plurality of AI automation assets and/or applications configured to facilitate operation of the respective automation sub unit;
analyze and manage people skills and resources for each of the one or more automation sub units;
manage training needs of human resources for each of the one or more automation sub units based on the analysis data;
develop and manage organization structures for the enterprise;
determine and manage AI automation workforce costs for each of the automation sub units; and
generate skill maps, skill metrics, skill trends, training outcomes, training effectiveness, training costs, workforce data, automation costs, automation cost trends, and combinations thereof for the enterprise.

5. The AI automation management system of claim 1, wherein the one or more processors are configured to execute the computer-readable instructions to:
manage information security for each of the plurality of AI automation assets and/or applications;
formulate and implement data relevance strategies for each of the plurality of AI automation assets and/or applications;
manage data de-biasing and quality checks for datasets used by the plurality of AI automation assets and/or applications;
evaluate data utilization efficiency and implement data change strategies based on the evaluated data utilization efficiency;
implement AI automation information management strategies for selective AI automation assets and/or applications having data availability lesser than a pre-defined threshold; and
generate security threat trends, data relevance metrics, data bias and data quality metrics, data change triggers, data usage trends, and combinations thereof.

6. The AI automation management system of claim 1, wherein the one or more processors are configured to execute the computer-readable instructions to:
evaluate and manage technology infrastructure requirements for the plurality of AI automation assets and/or applications;
manage green-ness and carbon foot print for the plurality of AI automation infrastructure assets and/or applications in accordance with the overall strategy for the enterprise;
define and implement a global technology change and operations management strategy for the plurality of AI automation assets and/or applications to manage changes resulting from service incidences, traces and events, client requirements, operational changes, or combinations thereof;
evaluate technology performance and innovation management for each of the plurality of AI automation assets and/or applications with respect to pre-determined benchmarks;
formulate and implement enterprise-level AI & automation infrastructure cost management and capacity utilization strategy across each of the plurality of AI automation assets and/or applications; and
determine technology management data, wherein the data comprises at least one of assets capacity trends, green scores, asset criticality metrics, cost metrics for each of the plurality of AI automation assets and/or applications or combinations thereof.

7. The AI automation management system of claim 1, wherein the one or more processors are configured to execute the computer-readable instructions to:
manage organizational change plans for the plurality of AI automation assets and/or applications;
evaluate and manage adoption models for the plurality of AI automation assets and/or applications;
establish and implement communication and trust management plans for the plurality of AI automation assets and/or applications;
manage AI and automation thought diversity management process for the plurality of AI automation assets and/or applications based on a plurality of diversity parameters;
formulate and implement enterprise level Environmental Sustainability & Green (ESG) strategies for each of the plurality of AI automation assets and/or applications; and
determine and track AI automation triggered organizational changes metrics, adoption rates, trust scores, carbon foot print data, or combinations thereof for the plurality of AI automation assets and/or applications.

8. The AI automation management system of claim 1, wherein the one or more processors are configured to execute the computer-readable instructions to:
manage and track human-AI collaboration strategy and outcomes for each of the plurality of AI automation assets and/or applications;
assess human behavioural impact of the human-AI collaboration for each of the plurality of AI automation assets and/or applications;
assess technology effectiveness of the human-AI collaboration for each of the plurality of AI automation assets and/or applications;
identify and/or assess STEP impact of the human-AI collaboration for each of the plurality of AI automation assets and/or applications;
assess innovation effectiveness of the human-AI collaboration for each of the plurality of AI automation assets and/or applications; and
measure and track at human-AI collaboration parameters, wherein the human-AI collaboration parameters comprise at least one of business impact metrics, behavioural impact data, user satisfaction scores, STEP impact data and adoption data.

9. The system of claim 1, wherein the system comprises an output module configured to display the output parameters corresponding to each of the plurality of AI automation assets to one or more users of the system.

10. An artificial intelligence (AI) automation management system, comprising:
one or more AI automation input modules configured to receive a plurality of input parameters corresponding to plurality of AI automation assets and/or applications of an enterprise, wherein the input parameters correspond to one or more of strategy, workforce, information, technology and culture related parameters;
one or more AI automation output modules communicatively coupled to at least one AI automation input modules, wherein the one or more AI automation output modules is configured to generate output parameters corresponding to each of the plurality of AI automation assets, wherein the output parameters comprise human-AI augmentation metrics, cost details, adoption metrics, impact on market share, profitability metrics, and combinations thereof; and
one or more AI processing modules one or more processing modules configured to analyze the plurality of input parameters received from the one or more AI automation input modules and the output parameters received from the one or more AI automation output modules to manage and/or facilitate operation of each of the plurality of AI automation assets and/or applications to deliver targeted outcomes for the enterprise.

11. The AI automation management system of claim 10, wherein the one or more AI processing modules are integrated with the AI automation input modules and the AI automation output modules.

12. The AI automation management system of claim 10, wherein the one or more AI processing modules is further configured to receive control factors for each of the plurality of AI automation assets and/or applications, wherein the control factors comprise factors related to trust and regulations, data security standards, bias mitigation strategies, social-technological-economic-political (STEP) factors, green and sustainability parameters, ethical AI practices, and combinations thereof;
receive technology parameters for each of the plurality of AI automation assets, wherein the technology parameters comprise parameters related to input data quality, bias, change relevance, algorithms deployed by the AI automation assets, assets catalogues, green and sustainability parameters of the infrastructure, and combinations thereof; and
analyze each of the control factors and technology parameters to manage and/or facilitate operation of each of the plurality of AI automation assets and/or applications to deliver the targeted outcomes for the enterprise.

13. The AI automation management system of claim 10, further comprising a data storage module configured to store the input parameters, output parameters, control factors, technology parameters, or combinations thereof.

14. The AI automation management system of claim 10, wherein the system is configured to monitor and track a plurality of interactions between the one or more AI automation input modules and the one or more AI automation output modules, wherein the interactions comprises an output from one or more modules being delivered as an input to another module.

15. The AI automation management system of claim 10, wherein the system is customizable by a user of the system based upon a type of enterprise and the types of the AI automation assets and/or applications of an enterprise.

16. A computer-implemented method for managing AI automation of an enterprise, the method comprising:
receiving input parameters for a plurality of AI automation assets and/or applications deployed for the enterprise, wherein the input parameters correspond to one or more of strategy, workforce, information, technology and culture related parameters;
receiving control factors for each of the plurality of AI automation assets and/or applications, wherein the control factors comprise factors related to trust and regulations, bias mitigation strategies, social-technological-economic-political (STEP) factors, green and sustainability parameters, ethical AI practices, and combinations thereof;
receiving technology parameters for each of the plurality of AI automation assets, wherein the technology parameters comprise parameters related to input data quality, bias, change relevance, algorithms deployed by the AI automation assets, assets catalogues, green and sustainability parameters and combinations thereof;
generating output parameters corresponding to each of the plurality of AI automation assets, wherein the output parameters comprise human-AI augmentation metrics, cost details, adoption metrics, impact on market share, profitability metrics, and combinations thereof; and
processing each of the input parameters, control factors, technology parameters and output parameters to manage and/or facilitate operation of each of the plurality of AI automation assets and/or applications to deliver targeted outcomes for the enterprise.

17. The computer-implemented method of claim 16, further comprising customizing the AI automation method based on type of enterprise, types of the plurality of AI automation assets and/or applications, governance guidelines, risk and lifecycle management, environment compliance, compliance standards, and combinations thereof.

18. The computer-implemented method of claim 16, further comprising managing the enterprise AI adoption and transformation strategies of the enterprise.

19. The computer-implemented method of claim 18, further comprising implementing and managing strategy and financial process, workforce, information, technology, culture and human-AI collaboration for the enterprise.

20. The computer-implemented method of claim 18, further comprising monitoring interactions between the one or more processes related to the strategy and financial process, workforce, information, technology, culture and human-AI collaboration for the enterprise.
